(19) United States
(12) Patent Application Publication
(10) Pub. No.: US 2016/0063949 A1
(43) Pub. Date: Mar. 3, 2016

(54) IMAGE PROCESSING SYSTEM, APPARATUS AND METHOD

(71) Applicants: KABUSHIKI KAISHA TOSHIBA, Tokyo (JP); Toshiba Lifestyle Products & Services Corporation, Tokyo (JP)

(72) Inventor: Masaki Tsuchida, Hamura Tokyo (JP)

(21) Appl. No.: 14/686,500

(22) Filed: Apr. 14, 2015

(30) Foreign Application Priority Data
Aug. 28, 2014 (JP) 2014-173926

(51) Int. Cl. G09G 5/00; H04N 5/44

(52) U.S. Cl. CPC G09G 5/005; H04N 5/44; G09G 5/006; G09G 2320/08; G09G 2370/042

(57) ABSTRACT

According to one embodiment, an image processing system which transmits a transmission video signal in which information indicating that an image is prepared by using a second reproduction color gamut standard which is capable of reproducing a color gamut wider than a first reproduction color gamut standard is described in control information in a predetermined description form, the control information being multiplexed in the transmission video signal.

### CROSS-REFERENCE TO RELATED APPLICATIONS

This application is based upon and claims the benefit of priority from Japanese Patent Application No. 2014-173926, filed Aug. 28, 2014, the entire contents of which are incorporated herein by reference.

### FIELD

Embodiments described herein relate generally to an image processing system, apparatus and method which optimize display characteristics of a display image.

### BACKGROUND

In the current broadcast standard or video format, the color gamut used at the time of transmitting an image signal is compressed more than the color gamut which can reproduce all the colors in the natural world.

A transmission standard is planned to be applied to the broadcast standard or video format for the next generation, allowing the transmission of an image signal which can express a color gamut wider than the current compressed color gamut.

However, at the moment, no method is defined for clearly showing the user whether the reproduced image is an image reproduced from an image signal transmitted according to the current transmission standard or is an image reproduced from an image signal transmitted according to the transmission standard which can express a color gamut wider than the image signal of the current standard.

Thus, when the color gamut of the reproduced program or image differs depending on the program or image, the user may consider that the image processing system or apparatus has some problems.

Embodiments described herein aim to provide an image processing system, apparatus and method which can clearly show the user that a program or image is based on a transmission standard which can transmit an image signal which can express a color gamut wider than the current compressed color gamut.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of an image processing system according to an embodiment;

FIG. 2 shows an example of an image processing apparatus (television apparatus) according to an embodiment;

FIG. 3 shows determination of color gamut information of an image processing apparatus (television apparatus) according to an embodiment as a software operation;

FIG. 4 shows an example of a display image according to a reproduction color gamut determination result obtained from color gamut information according to an embodiment;

FIG. 5 shows an example of a data structure of control information including color gamut information obtained by an image processing apparatus (television apparatus) from a broadcast wave (program) according to an embodiment;

FIG. 6 shows an example of a data structure of control information including color gamut information obtained by an image processing apparatus (television apparatus) from a broadcast wave (program) according to an embodiment;

FIG. 7A shows an example of a data structure of control information including color gamut information obtained by an image processing apparatus (television apparatus) from a broadcast wave (program) according to an embodiment; and

FIG. 7B shows an example of a data structure of control information including color gamut information obtained by an image processing apparatus (television apparatus) from a broadcast wave (program) according to an embodiment.

### DETAILED DESCRIPTION

Various embodiments will be described hereinafter with reference to the accompanying drawings.

In general, according to one embodiment, an image processing system which transmits a transmission video signal in which information indicating that an image is prepared by using a second reproduction color gamut standard which is capable of reproducing a color gamut wider than a first reproduction color gamut standard is described in control information in a predetermined description form, the control information being multiplexed in the transmission video signal.

Embodiments will now be described hereinafter in detail with reference to the accompanying drawings.

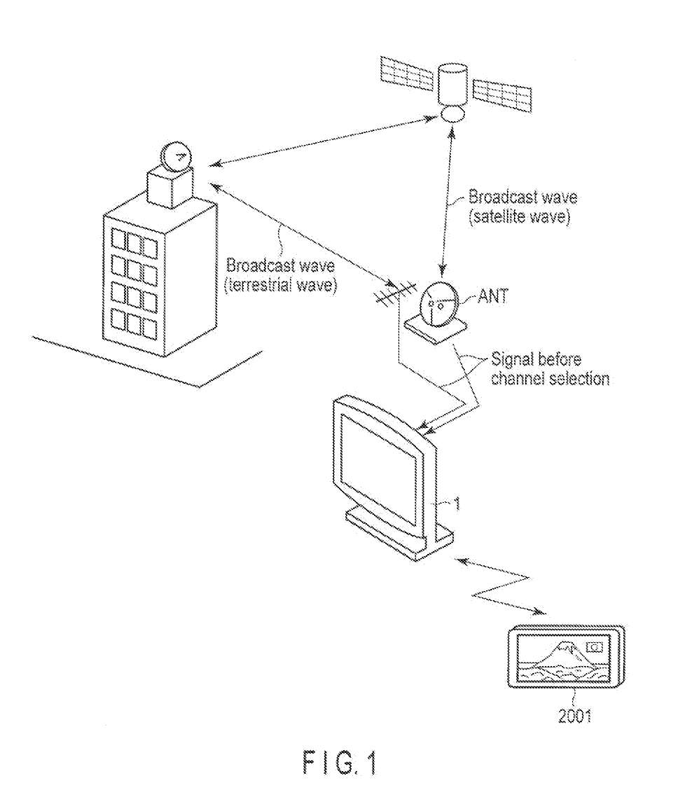

FIG. 1 shows an example of an image processing system according to an embodiment.

In the image processing system shown in FIG. 1, an image reproduction apparatus (image processing apparatus) 1 receives a broadcast wave (a terrestrial wave and a satellite wave) transmitted by a broadcasting station which is the provider of a program through an antenna ANT. The image reproduction apparatus is capable of obtaining an image from an external image supplier such as a video camera and a portable terminal device 2001 which can capture a picture. In this case, an image may be obtained based on, for example, a close-range wireless communication system, or a wired transmission system using a cable for connection.

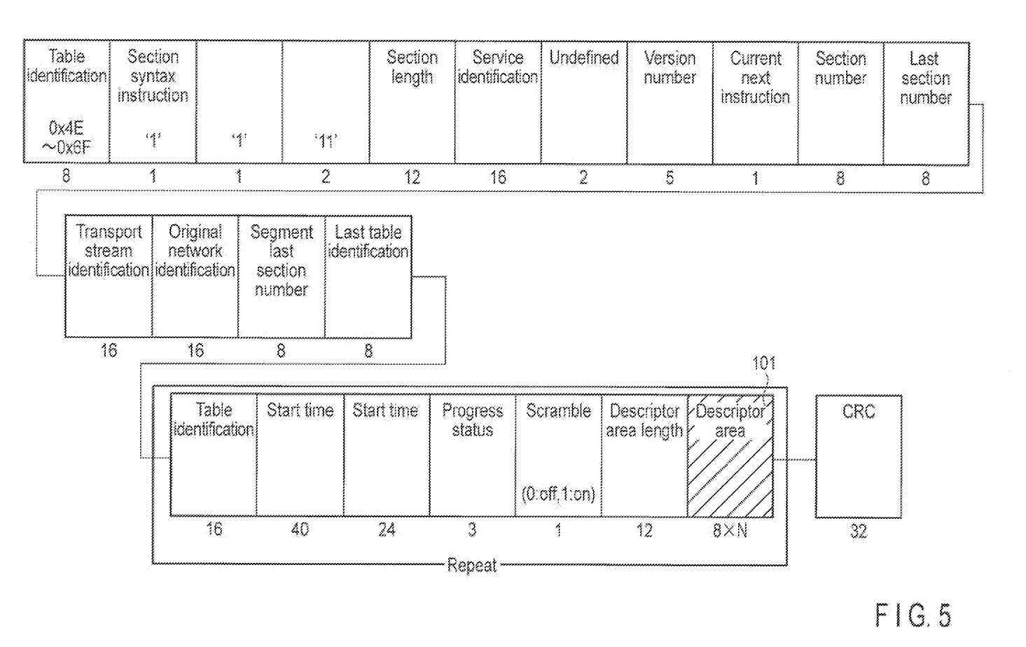

In the image processing system shown in FIG. 1, a broadcast wave received by the image reproduction apparatus 1 or an image obtained from an external image supplier includes at least color gamut information in conformity with the standard defined by the Association of Radio Industries and Businesses (ARIB). This configuration is explained later by reference to FIG. 5 and the like.

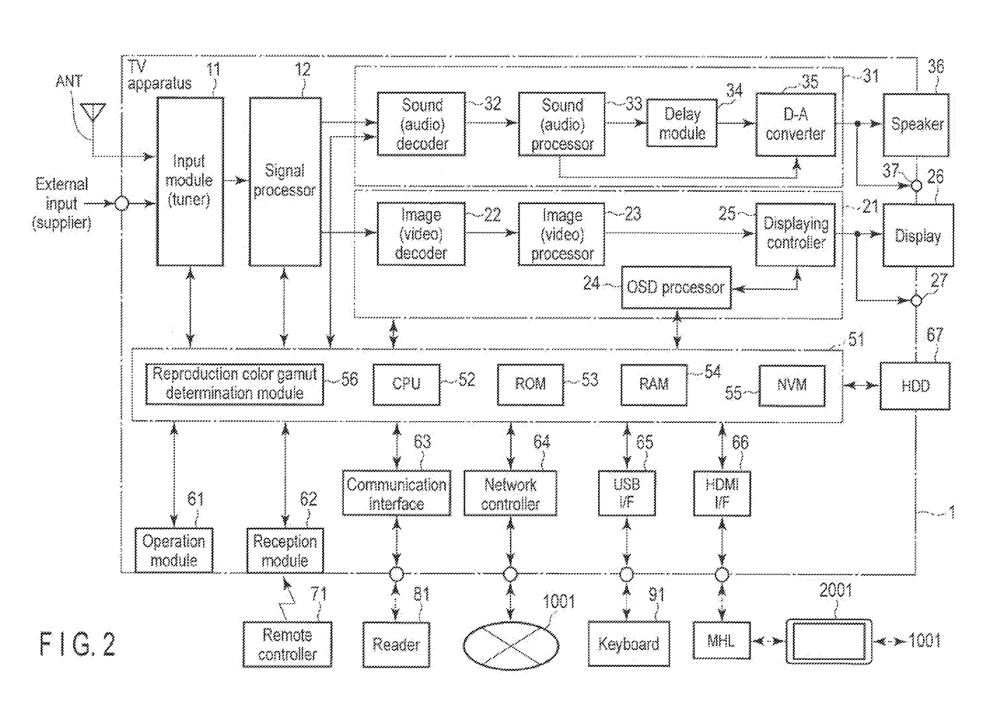

FIG. 2 shows an example of an image reproduction apparatus according to an embodiment. The image reproduction apparatus 1 may integrally comprise a display module (display). The display module may be formed such that the display module does not contact with the image reproduction apparatus 1 and displays a program which is wirelessly transmitted by an image storage device. The elements or structures explained below may be realized as software by a processor, or in other words, a microcomputer (central processing unit (CPU)), or may be realized as hardware. In the following explanation, for example, a broadcast may be offered by a broadcaster (broadcasting station) as an electric wave spread across the air, or may be distributed by a distributor over a network such as a cable network (including a fiber-optic network) and an Internet Protocol (IP) network. A broadcast includes images, sound or music, or images and sound or music, and shows a form which provides various programs each having a certain period of time (broadcasting time) as a unit. A program may be called content or a stream. Images include moving images, still images, text (information indicated by characters or symbols shown by code strings), and arbitrary combinations of them.

In FIG. 2, the image reproduction apparatus (hereinafter, referred to as a television apparatus) 1 comprises, for example, an input module (tuner) 11, a signal processor (TS separation module) 12, an image processing block 21, an audio processing block 31 and a main control block 51.

The antenna ANT which receives broadcasts via a space wave (a terrestrial wave or a satellite wave) is connected to the input module 11. In addition, as an external image supplier, for example, a set-top box (STB) or a video camera is connected to the input module 11. The video camera may be a portable terminal device which can capture a picture such as a tablet computer.

A broadcast which is input in the input module 11 or an external input image from a video camera, etc., is separated by the signal processor (TS separation module) 12 into a transport stream (TS), or in other words, into a video signal (video), an audio signal (audio) and control information. The control information includes service information (SI) or program sequence information and an event information table (EIT). In the SI, for example, the distribution rule, content, and schedule or timing of the TS are described. The EIT indicates information related to a program such as a program name, broadcasting time and date, and broadcast content. The EIT includes a description showing whether the standard which is related to color gamut information of a target program and which is used when the program (image) is recorded is BT.709 or BT.2020. BT.709 is based on the high-definition television studio standard which is the ARIB standard. BT.2020 is based on the ultra-high-definition television studio standard which can express a color gamut wider than BT.709. The SI is information which is extended from program specific information (PSI) showing to which program an elementary stream (ES) which includes a moving image and audio included in the TS belongs. Thus, the SI includes program information, etc. As the control information, for example, an exchangeable-image-file format (Exif) and a design rule for camera file system (DCF) are attached to an image provided by a video camera.

A video signal (video) is decoded by an image decoder 22 of the image processing block 21, and is output as a digital video signal (video output).

A display 26 and a speaker 36 are connected to the image processing block 21 and the audio processing block 31 respectively.

The image processing block 21 includes, for example, the image (video) decoder 22, an image (video) processor 23, an on-screen-display (OSD) processor 24, and a displaying controller 25.

The image processor 23 converts the digital video signal decoded by the image decoder 22 into a predetermined resolution and output system displayable in the display 26. The displaying controller 25 converts the video signal converted by the image processor 23 into a display drive signal which enables display (image reproduction) suitable for the display 26. The displaying controller 25 synthesizes an on-screen-display (OSD) signal from the OSD processor 24 and the display drive signal. For example, the output of the displaying controller 25 may be output to an output terminal 27 connectable with an external monitor device or projection device (projector) which is connected to the outward.

The audio processing block 31 includes, for example, a sound (audio) decoder 32, a sound (audio) processor 33, a delay module 34 and a digital-to-analog (D-A) converter 35.

The sound processor 33 converts an audio signal (audio) into a predetermined format which enables the speaker 36 to appropriately reproduce the audio signal, decoded by the sound decoder 32. The D-A converter 35 converts the audio signal converted by the sound processor 33 into an analogue audio output signal. The speaker 36 is connected to the D-A converter 35, the speaker 36 outputs audible sound (analog sound (audio) output). The output of the D-A converter 35 may branch to an output terminal 37 connectable with an audio-visual (AV) amplifier, for example. The audio signal which is input in the D-A converter 35 is controlled in such a way that a predetermined amount (time) of delay is applied by the delay module 34 in accordance with the content type. For example, when the content is a game, the delay (time) defined by the delay module 34 is shorter than the delay (time) which is applied when a broadcast signal (program) is reproduced.

An operation module 61 inputs, in the main control block 51, a control command corresponding to a direct operation by the user.

A reception module 62 inputs, in the main control block 51, a command corresponding to an instruction (operation input) by a remote control terminal (remote controller) 71.

A communication interface 63 realizes wireless communication with a close-range wireless communication device conforming to the Wireless Fidelity (Wi-Fi) standard, etc. As the close-range wireless communication standard, for example, the Bluetooth (registered trademark) standard or the near-field communication (NFC) can be employed. Either a wired system or a wireless system can be used for the communication interface 63. For example, a communication unit which can exchange a signal with a wireless keyboard or a mouse is connected to the communication interface 63. For example, the communication interface 63 can communicate with a card reader 81 which can communicate with a contactless card medium.

A network controller 64 controls, for example, acquisition and transmission of various types of information from an external network (the Internet [network 1001]), and access to the Internet (network 1001).

For example, a USB interface 65 realizes use of an external device compatible with the USB standard such as a keyboard.

An HDMI controller 66 realizes wired communication between devices using the HDMI standard or MHL standard.

An HDD 67 stores received (obtained) content. A video signal and audio signal, etc., which are retained by the HDD 67 can be output to other devices or the network 1001 (service servers 201, . . . , N01) via the network controller 64. The video signal and audio signal, etc., which are input via the network controller 64 from other devices can be also reproduced directly in the display 26 and the speaker 36 without retention by the HDD 67.

The main control block 51 includes, for example, a CPU (main processing circuit) 52, a read-only memory (ROM) 53 which retains a control program executed by the CPU 52, a random-access memory (RAM) (working memory) 54 which provides the CPU 52 with a working area, a nonvolatile (rewritable) memory (NVM) 55 which retains various types of configuration information and control information, and a reproduction color gamut determination module 56. For example, the operation module 61, the reception module 62, the communication interface 63, the network controller 64, the Universal Serial Bus (USB) interface 65, the High-definition Digital Media Interface (HDMI(registered trademark)) controller 66 and the hard disk drive (HDD) 67 are connected to the main control block 51.

The main block 51 controls the above modules and elements by using the CPU 52 according to operation information (control input) from the operation module 61, and operation information (control input) which is received by the reception module 62 from the remote controller 71.

The main control block 51 can store, in the HDD 67, the video signal and audio signal, etc., which are output by the video decoder 22 and the audio decoder 32 according to operation (control input) by the user. When the video signal and audio signal, etc., are stored in the HDD 67, the main control block 51 encrypts the signals, and converts them into a predetermined record format. According to operation (instruction input) by the user from the remote controller 71, etc., the main control block 51 reads a desired video signal and sound signal, etc., from the HDD 67, decodes the signals, supplies them to the image decoder 22 and the sound decoder 32, and executes image display and audio reproduction.

The main control block 51 can obtain subtitle information (including live subtitles captioned from voice uttered by an anchor (an announcer) in a news program) and electronic program guide (EPG) information from the TS separated by the signal processor (TS separation module) 12 by using a program or application held by the NVM 55 or the ROM 53 or firmware of the CPU 52.

From the EIT of program information included in the SI (program sequence information) of control information separated by the signal processor 12, the main control block 51 extracts information of whether the standard which is related to color gamut information of a target image signal and which is used when the program (image) is recorded is a first standard according to, for example, the HDTV standard (in short, BT.709 of ARIB), or a second standard according to, for example, the UHDTV standard (in short, BT.2020 in conformity with the ultra-high-definition studio standard which can express a color gamut wider than BT.709). The main control block 51 notifies the reproduction color gamut determination module 56 of the extracted information. Examples of descriptions of the EIT in the SI are explained later (regarding which description of the EIT is referred to by the main control block 51). The image supplier is a video camera (external input), for example, the color gamut information can be obtained from the above-described DCF and Exif in the control information.

In accordance with the color reproduction ability (display ability) of the display 26, the reproduction color gamut determination module 56 instructs the displaying controller 25 and the CPU 52 to perform color gamut reproduction according to the first standard (BT.709) or color gamut reproduction according to the second standard (BT.2020).

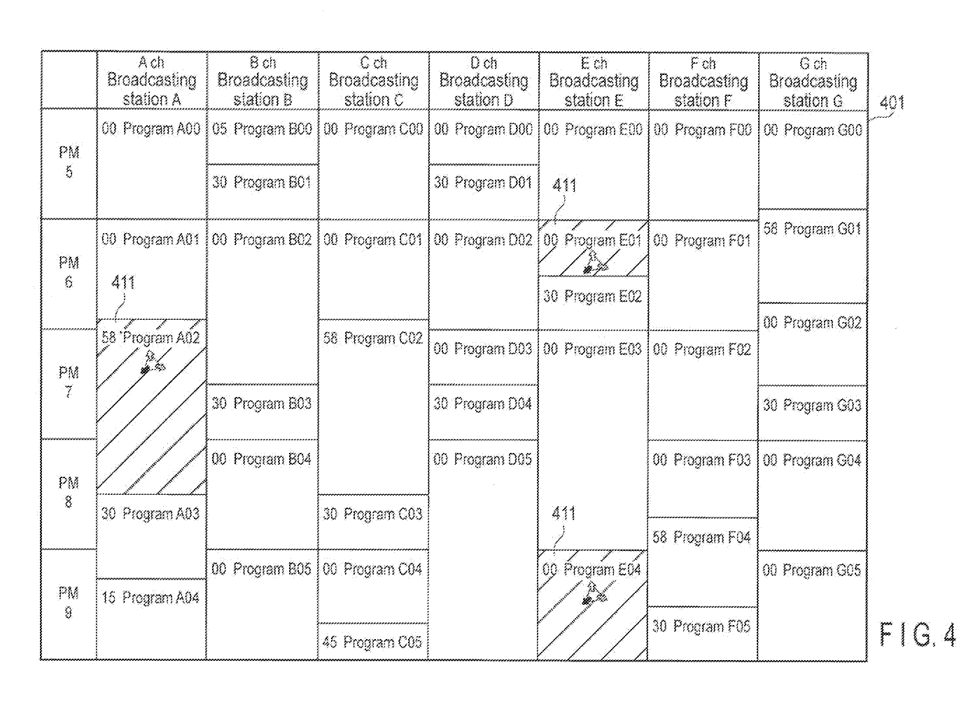

The main control block 51 stores, for example, in the RAM 54, the information related to the reproduction color gamut determined by the reproduction color gamut determination module while the display 26 of the television apparatus (image processing apparatus) 1 is turned on, or while a video signal is output in the output terminal 27. In the television apparatus 1, for example, the information related to the reproduction color gamut determined by the reproduction color gamut determination module 56 is retained in the RAM 54 such that information indicating that the reproduction color gamut is a wide color gamut can be displayed for each program (image) displayed in a program guide (or a navigation screen to be viewed) when the display of the program guide (or the navigation screen to be viewed) is requested as an instruction input by the user from the remote controller terminal (remote controller) 71. Accordingly, the obtained color gamut information is retained in the main control block 51 (RAM 54) such that the information can be displayed (additionally displayed) in display for a target program of the program guide (or the navigation screen) while the main power source of the television apparatus (image processing apparatus) 1 is turned on. When the display of the program guide (or the navigation screen) is requested (by a user's operation), and one or more than one program (image) having a wide reproduction color gamut is present in the programs in the displayed time zone (or in the images displayed on the navigation screen), an image signal is output via the OSD processor 24 and the displaying controller 25 such that the signal can be displayed by the display (display portion) 26 or a display device connected to the output terminal 27. The image signal is produced by synthesizing, on the reproduction image (display image of the program guide or the navigation screen), a mark (image), a character string or both of them showing the adoption of a wide color-gamut broadcast compared with a program having a reproduction color gamut broadcast according to the current TV standard. An example of this configuration is explained later with reference to FIG. 4.

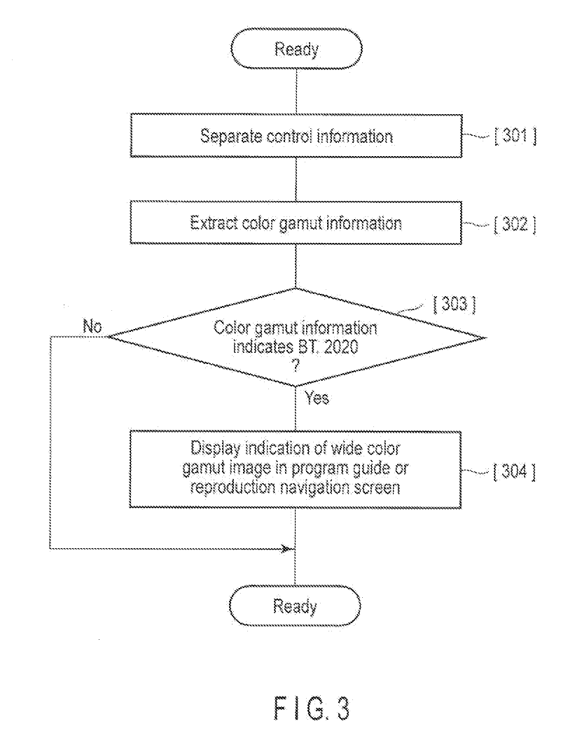

FIG. 3 shows determination of color gamut information supplied to the reproduction color gamut determination module shown in FIG. 2 as a software operation.

The signal processor 12 separates control information from the obtained (received) image signal [301].

Color gamut information is extracted from the separated control information [302].

A determination operation is performed regarding whether the extracted color gamut information indicates that the color gamut is based on the first standard (BT.709) or the second standard (BT.2020) which can express a color gamut wider than the first standard [303].

In a case where the extracted color gamut information indicates that the color gamut is based on the second standard (BT.2020) [303-YES], a control code is prepared and is stored in a predetermined storage area such as the RAM 54 in order to display, in display corresponding to an applicable program (image), an identifier (an icon, a symbol or a character string) indicating that the program (image) is recorded in the UHDTV standard (at the same time) at the time of displaying a program guide or a reproduction navigation screen (in a case where a flag is prepared in advance, the flag is on) [304]. In a case where the color gamut information indicates that the color gamut is based on the first standard (BT.709) in conformity with the HDTV, the process is terminated [303-NO].

FIG. 4 shows an example of a display image according to the reproduction-color-gamut-determination result obtained from the color gamut information. The display image shown in FIG. 4 is an example of a display image which corresponds to an image output from the display controller and which is displayed by the display. In the image reproduction apparatus (image processing apparatus) 1, a case where an image output is output or an image signal which can output the image output can be generated is included.

In FIG. 4, a mark 411 is displayed in a program guide 401. In the program guide 401, specifically, the mark 411 is displayed in display indicating each of program E01 which lasts for thirty minutes from 6:00 p.m. in an E broadcasting station (E channel), program E04 which lasts for one hour from 9:00 p.m. in the same broadcasting station, and program A02 which starts at 6:58 p.m. and ends at 8:30 p.m. in an A broadcasting station (A channel). The mark 411 shows that a wide-color-gamut broadcast is adopted compared with a program broadcast according to a reproduction color gamut in the current TV standard. Instead of the mark display, for example, a character string such as “wide color gamut broadcast” or “2020” may be displayed, or a mark and a character string may be displayed together. The mark 411 may be visually associated with a color gamut. For example, the three primary colors of red (R), green (G) and blue (B) may be arranged.

FIG. 5 shows a data structure of an EIT obtained by the image reproduction apparatus (television apparatus) 1 from a broadcast wave (program).

The EIT structure shown in FIG. 5 complies with ARIB_STD-B10 Program Sequence Information Used for Digital Broadcasting Version 5.1 (revised Sep. 25, 2012), which is the standard defined by ARIB. However, the EIT does not consider the identification of whether the program is produced according to the first standard (BT.709) or the second standard (BT.2020) which can reproduce a color gamut wider than the first standard as the color gamut information.

Information indicating whether the program is produced according to BT.2020 (second standard) or BT.709 (first standard) is described in the EIT of the SI information such that the information can be identified on the receiver (television apparatus 1) side. By this configuration, it is possible to obtain (extract) color gamut information in the television apparatus 1 (receiver).

The EIT can convey information related to a program, such as a program name, broadcasting time and date, and broadcast content, to a receiving device. As the data structure of the EIT, a descriptor area 101 is provided before a CRC_32 (CRC) (the CRC is the final field for each table. The descriptor area 101 can transmit information of different types of events by using different descriptors. In the descriptor area 101, information can be multiplexed. A plurality of types of descriptors defined such that event information can be described in the descriptor area 101 of the EIT are prepared in advance by ARIB. A short event descriptor which allows a description in the descriptor area 101 and a description of a program name and the brief explanation of a program essential for the EIT, and an extended event descriptor which allows a description in the descriptor area 101 and a description of detailed information related to a program and which can be added to the short event descriptor are suitable for the description of information of each program, or specifically, color gamut information of each program.

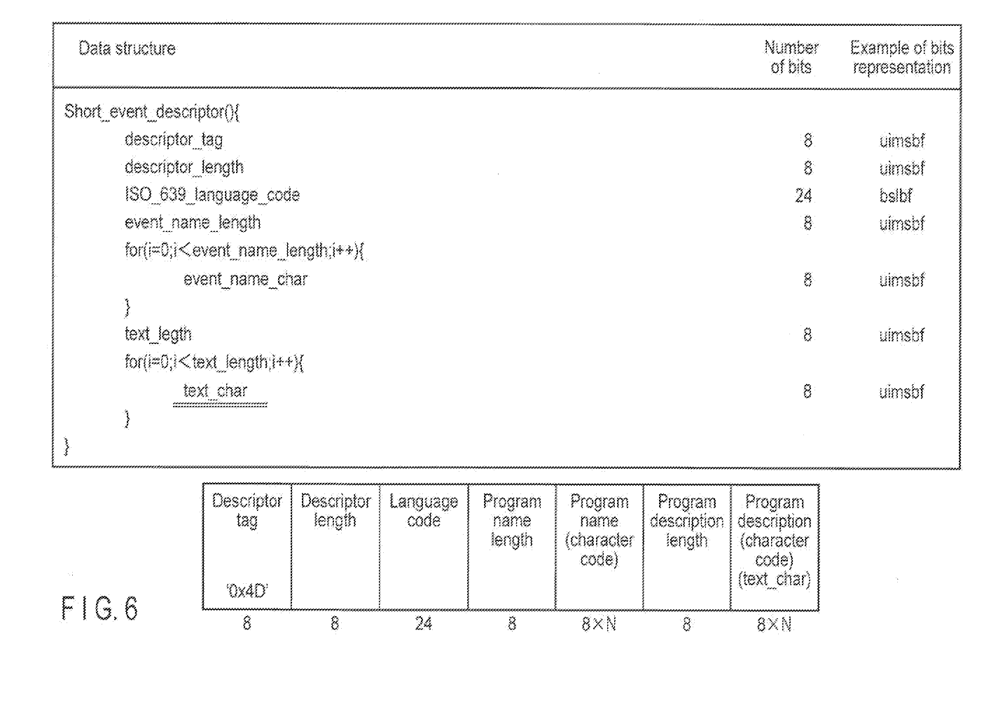

FIG. 6 shows a short event descriptor (Short_event_descriptor) and its data structure.

This specification explains the content of the short event descriptor (Short_event_descriptor) below.
descriptor_tag (descriptor tag):
identifying each descriptor, and described in ISO/IEC 13818-1.
descriptor_length (descriptor_length):
defining the whole byte length of the data portion of the immediately-after descriptor length.
ISO_{—}639_language_code (language code):
showing the language of the subsequent character information field by a three-alphabet-character code.
event_name_length (program length name):
showing the byte length of the subsequent program name.
event_name_char (program name):
showing a program name.
text_length (program description length):
showing the byte length of the subsequent program description.
text_char (program description):
describing the explanation of a program.

As an example of actual description of color gamut information, a character string showing the wide color gamut BT.2020 (for example, BT.2020) is multiplexed (described) in the place of text_char which is the program description portion in the data structure of a short event descriptor. By this configuration, it is possible to notify the television apparatus (receiver) that the content of the current program is produced according to a wide color gamut. However, when the description of color gamut information is multiplexed in the short event descriptor, it is necessary to consider an agreement for clearly distinguishing a description of program content from a message indicating a wide color gamut since the short event descriptor is prepared as a descriptor essential for the EIT.

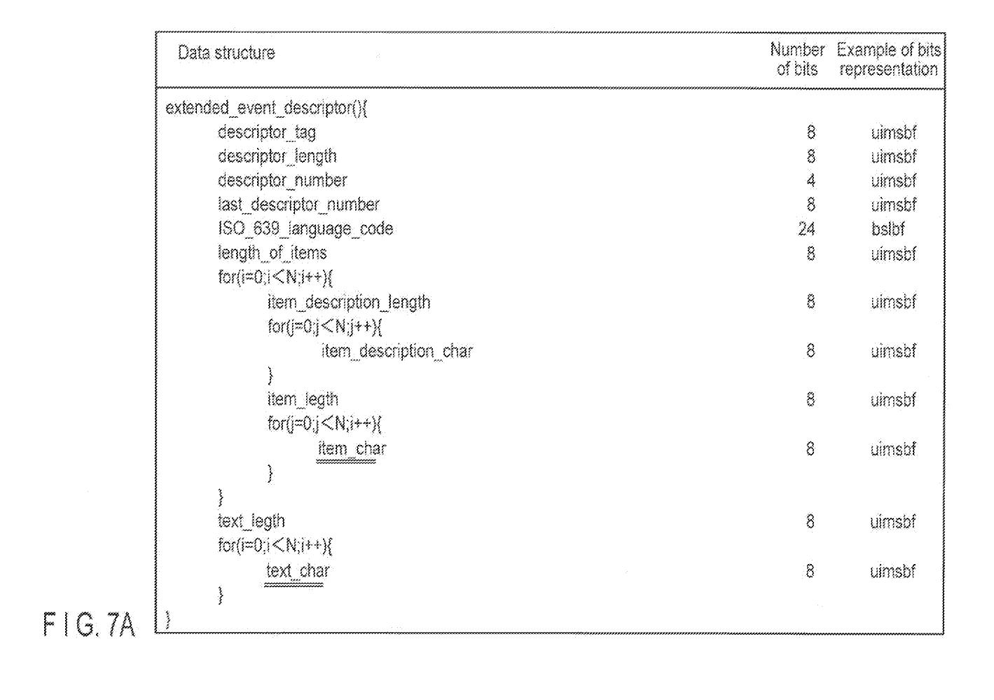

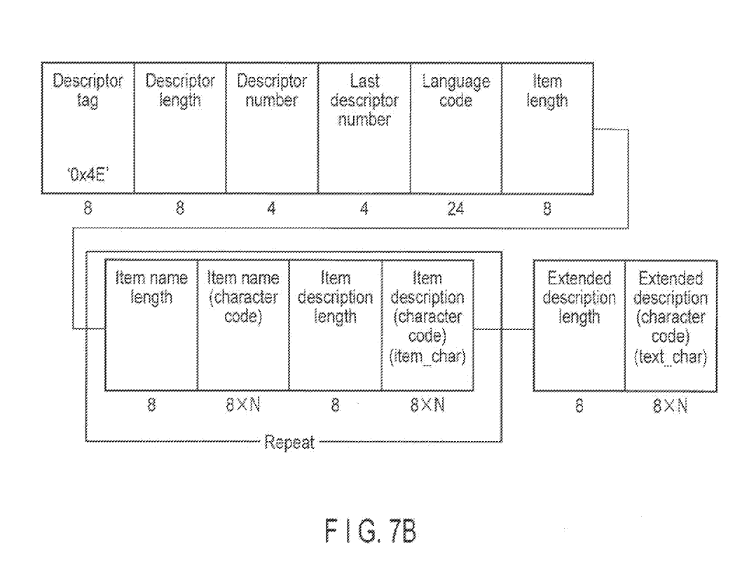

FIG. 7A and FIG. 7B show an extended event descriptor (Extended_event_descriptor) and its data structure.

This specification explains the content of the descriptor (Extended_event_descriptor) below.

descriptor_tag (descriptor tag):
identifying each descriptor, and described in ISO/IEC 13818-1.
descriptor_length (descriptor length):
defining the whole byte length of the data portion of the immediately-after descriptor length.
descriptor_number (descriptor number):
associating information which cannot be put in one descriptor.
last_descriptor_number (last descriptor number):
showing the number of the last extended event descriptor of the associated descriptor set.
ISO_{—}639_language_code (language code):
showing the language of the subsequent character information field by a three-alphabet-character code.
lenth_of_items (item length):
showing the byte length of the subsequent item.
item_description_length (item name length):
showing the byte length of an item name.
item_description_char (item name):
defining the character description of an item name.
item_length (item description length):
showing the byte length of an item description.
item_char (item description):
defining the character description of an item.
text_length (extended description length):
showing the byte length of an extended description without an item.
text_char (extended description):
defining a character description without an item.

As an example of actual description of color gamut information, a character string showing the wide color gamut BT.2020 (for example, BT.2020) is multiplexed (described) in the place of item_char which is the item description portion or text_char which is the extended description portion in the data structure of the extended event descriptor. By this configuration, it is possible to notify the television apparatus (receiver) that the content of the current program is produced according to a wide color gamut. The extended event descriptor can be arbitrarily added to the short event descriptor, and does not describe the program content and the message of the wide color gamut in the same place. This is different from the example of FIG. 6 in which wide color gamut information is multiplexed in the short event descriptor. Therefore, it is possible to clearly distinguish a program content description from a message indicating a wide color gamut.

It is possible to use a descriptor which is independently prepared from the short event descriptor shown in FIG. 6 or the extended event descriptor shown in FIG. 7A and FIG. 7B and is newly prepared as color gamut information.

In this manner, the transmission side multiplexes, as color gamut information, program information indicating whether the target image signal corresponds to an image recorded (produced) according to BT.709 in conformity with the current HDTV standard or an image recorded (produced) according to BT.2020 in conformity with the UHDTV standard, in the SI (program sequence information) which is separated from the broadcast data stream (program) and describes, for example, a distribution system, content and schedule/timing. The receiver side separates original color gamut information of a program (content) from reception signal, and displays an icon or identification display showing that the program is produced according to the wide color gamut BT.2020 in an information display function such as a television program guide. Thus, the color gamut information is informed to the user. While the user identifies whether the viewing program is recorded according to a wide color gamut or an optimal color reproduction process is set in the program, etc., the user can enjoy the image (program).

When the receiver side (television apparatus) analyzes the message which is multiplexed on the transmission side and which shows that the image is produced (recorded) according to a wide color gamut, and recognizes that the image of the target program is produced (recorded) according to a wide color gamut, an icon or identification message indicating that the image is produced (recorded) according to a wide color gamut is displayed for each program (image) displayed in the program guide (or the navigation screen to be viewed). This configuration enables the user to recognize that the program (image) currently viewed by the user is a program (image) produced (recorded) according to a wide color gamut on the broadcasting station side or a video camera device, etc., for each program. In this manner, even if each program (image) to be viewed has a different reproduction color gamut (color tone/color shade/vividness, etc.), the user can understand the reason and further enjoy the program (image).

In a television apparatus (receiver side) which can reproduce an image (program) according to BT.2020 (ARIB) which is one of the reproduction color gamuts applied in the broadcast standard for the next generation including a 4K (3840×2160) broadcast, or a display device (monitor device/television apparatus) adopting a display which can express (reproduce) a color gamut wider than a color gamut according to BT.709 which is the current HDTV standard, transmission of an image signal (program) by using the BT.2020 standard enables the display of an image according to a wide color gamut. In this manner, the user can enjoy a vivid image (program).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments. The accompanying claims and their equivalents are intended to cover such forms or modifications as would fall within the scope and spirit of the inventions.

Various embodiments can be implemented as follows.

An embodiment is an image processing system according to ARIB BT.2020 standard which can transmit image content which can express a wide color gamut. In the system, the transmission side multiplexes color gamut information indicating according to which standard the image of the content is recorded, for example, indicating that the image is produced (recorded) according to BT.2020, in the SI (program sequence information) which is a data group describing the distribution system, content and schedule/timing of the broadcast data stream.

Another embodiment is an image processing system in which color gamut information is multiplexed in a description place of a data group (data multiplexing portion). The description place is a descriptor used for the data structure of the event information table (EIT) indicating information related to a program out of tables used for program sequence information of the digital broadcast standard.

Another embodiment is an image processing system in which the descriptor in the data structure of the EIT is a descriptor usable in the EIT standardized by ARIB. The descriptor is a short event descriptor, an extended event descriptor or a descriptor added as color gamut information.

Another embodiment is an image processing apparatus which can display, in an information display function such as a program guide, information which can display a reproduction color gamut according to color gamut information separated from a reception signal of image content in the second standard which can transmit image content which can express a color gamut wider than a reproduction color gamut according to the current first standard, for each image content.

What is claimed is:

1. An image processing system which transmits a transmission video signal in which information indicating that an image is prepared by using a second reproduction color gamut standard which is capable of reproducing a color gamut wider than a first reproduction color gamut standard is described in control information in a predetermined description form, the control information being multiplexed in the transmission video signal.

2. The image display apparatus of claim 1, wherein when the control information is multiplexed in a data group of the transmission video signal in the predetermined description form, the control information is multiplexed in SI (program sequence information) which is a data group in which items including a distribution system, content and a schedule/timing in the transmission video signal are described.

3. The image display apparatus of claim 2, wherein the data group in which the control information is multiplexed in the predetermined description form is an event information table (EIT) in the SI, and the control information is described in a descriptor used for a data structure in the EIT.

4. An image processing apparatus comprising:
a separation module which separates control information from an obtained image signal;
an extraction module which extracts color gamut information from the control information separated by the separation module;
a determination module which determines if the color gamut information extracted by the extraction module includes a description indicating conformance to a second standard which is capable of expressing a color gamut wider than a first standard; and
a reproduction color gamut management module which holds a determination result of the determination module such that such that identification information indicating that an image is produced according to the second standard is allowed to be displayed in information display corresponding to a target image signal when the determination result of the determination module shows the conformance to the second standard.

5. The image processing apparatus of claim 4, wherein the extraction module extracts the color gamut information from a description of an event information table (EIT) included in the control information separated from the image signal.

6. The image processing apparatus of claim 4, wherein the determination module determines the color gamut information according to a description of a short event descriptor in the description of the EIT included in the control information.

7. The image processing apparatus of claim 4, wherein the determination module determines the color gamut information according to a description of an extended event descriptor in the description of the EIT included in the control information.

8. The image processing apparatus of claim 4, wherein the determination module determines the color gamut information according to a specific description related to color gamut information in the description of the EIT included in the control information.

9. An image processing method, comprising:
separating control information from an obtained image signal;
extracting color gamut information from the separated control information; and
holding, when the extracted color gamut information includes a description indicating conformance to a second standard which is capable of expressing a color gamut wider than a first standard, a determination result such that identification information indicating that an image is produced according to the second standard is allowed to be displayed in information display corresponding to a target image signal.
